(19) United States
(12) Patent Application Publication
(10) Pub. No.: US 2023/0263208 A1
(43) Pub. Date: Aug. 24, 2023

(54) METHOD AND APPARATUS FOR THREE-DIMENSIONALLY FORMING FOOD BY IRRADIATING MIXTURE OF STARCH POWDER AND WATER WITH LASER LIGHT

(71) Applicant: NATIONAL UNIVERSITY CORPORATION YAMAGATA UNIVERSITY, Yamagata (JP)

(72) Inventors: Kosuke AISO, Yonezawa-shi, Yamagata (JP); Masaru KAWAKAMI, Yonezawa-shi, Yamagata (JP); Yuki KAINUMA, Yonezawa-shi, Yamagata (JP); Hidemitsu FURUKAWA, Yonezawa-shi, Yamagata (JP); Junichi TAKAHARA, Kashihara-shi, Nara (JP)

(73) Assignee: NATIONAL UNIVERSITY CORPORATION YAMAGATA UNIVERSITY, Yamagata (JP)

(21) Appl. No.: 18/007,280

(22) PCT Filed: Jul. 29, 2021
(86) PCT No.: PCT/JP2021/028018

§ 371 Date: Jan. 27, 2023

(30) Foreign Application Priority Data
Jul. 30, 2020 (JP) 2020-129585

(51) Int. Cl. A23P 20/20; A23L 29/212; A23L 5/30; B33Y 10/00; B33Y 30/00; B33Y 50/02

(52) U.S. Cl. CPC A23P 20/20; A23L 29/212; A23L 5/30; B33Y 10/00; B33Y 30/00; B33Y 50/02; A23P 2020/253

(57) ABSTRACT

Provided is a method which is capable of three-dimensionally forming a food into a desired shape such as a complicated shape or a hollow shape, using a starch powder as a raw material. The method for three-dimensionally forming a food using a starch powder as a raw material comprises the steps of: mixing a starch powder and water together to provide a mixture of the starch powder and the water; irradiating a part of the mixture with laser light to cause starch particles of the starch powder to swell due to the water to form swollen starch particles, followed by causing the swollen starch particles to gelatinize to form gelatinized starch particles, and causing the gelatinized starch particles to gelate, thereby obtaining gelated starch: and extracting the gelated starch from the mixture, wherein the step of irradiating includes irradiating the mixture with the laser light, according to a pattern predetermined based on a three-dimensional shape of a food.

### TECHNICAL FIELD

The present invention relates to a method and apparatus (3D food printer) for three-dimensionally forming a food product by using a starch powder as a raw material and irradiating a mixture of the starch powder and water with laser light. In particular, the present invention relates to a method and apparatus capable of forming a food made from starch to have any desired shape, and providing the food immediately for edible use.

### BACKGROUND ART

In recent years, the development of 3D food printers has been actively conducted. For example, a 3D food printer having a system configured to extrude food by a screw can output a paste or gel-like food. This system can form a soft food but cannot form a hard food. Further, it is difficult for this system to form a food having a hollow shape or a complicated shape.

There has also been known an inkjet-type 3D food printer configured to bind a sugar powder by spraying the sugar powder with dedicated edible ink having various flavors. This system is based on the premise of using a special sugar-based edible raw material, and a food that can be formed by this system is limited to sugar confectionery or the like.

Further, there has been known a system configured to conduct shape forming by a dispenser, and then conduct cutting or browning by a laser

For example, US-A1 2019/0110505 discloses a method used in a printer comprising a nozzle through which food passes during a printing process, wherein the method comprises, when the food exits from the nozzle to form an edible structure, irradiating the food with a first t laser of visible light for cooking a central portion of the food and a second laser of infrared light for browning at least part of the food.

However, this method is merely intended to form dough prepared by mixing flour and water, into a certain shape by means of extrusion from the nozzle, or the like, and then further cook and brown the dough by laser irradiation.

Heretofore, there has been no case where 3D printing (three-dimensional formation) of a food is attained by irradiation of laser light.

### CITATION LIST

[Patent Document]
Patent Document 1: US-A12019/0110505

### SUMMARY OF INVENTION

### Technical Problem

It is an object of the present invention to provide a technique capable of three-dimensionally form a food with a desired shape such as a complicated shape or a hollow shape, using a starch powder as a raw material, without using dough-like edible ink which has been supplied from a dispenser such as a nozzle in conventional techniques.

### [Solution to Technical Problem]

The present inventors have found that irradiating a mixture of a starch powder and water (starch powder-water mixture) with laser light can cause starch in an irradiated part of the mixture to swell, gelatinize and gelate, and therefore a food composed of the gelated starch and having a desired shape can be formed by irradiating the mixture with laser light according to a predetermined pattern and that the gelated starch can be easily separated from the starch powder-water mixture, and therefore a three-dimensionally formed food can be obtained by extracting the gelated starch from the mixture, and have arrived at the present invention.

The present inventors have also found that surprisingly, the degree of the swelling, gelatinization and gelation of starch can be changed by additionally adding a pigment to the starch powder-water mixture, and controlling the amount of the pigment, without requiring the combination use of a plurality of lasers having different wavelengths as in conventional techniques, and have arrived at the present invention.

Specifically. the present invention provides a method for three-dimensionally forming a food using a starch powder as a raw material, wherein the method comprises the steps of: mixing a starch powder and water together to provide a mixture of the starch powder and the water; irradiating a part of the mixture with laser light to cause starch particles of the starch powder to swell due to the water to form swollen starch particles, followed by causing the swollen starch particles to gelatinize to form gelatinized starch particles, and causing the gelatinized starch particles to gelate, thereby obtaining gelated starch; and extracting the gelated starch from the mixture, wherein the step of irradiating includes irradiating the mixture with the laser light, according to a pattern predetermined based on a three-dimensional shape of a food.

The starch powder is contained in the mixture preferably at a concentration of 20% by mass to 80% by mass, more preferably at a concentration of 40% by mass to 60% by mass.

The mixture may further comprise a pigment.

In this case, the pigment is preferably an edible pigment

Further, the pigment preferably exhibits absorption at a wavelength of the laser light.

The pigment is contained in the mixture preferably at a concentration of 0.001% by mass to 0.5% by mass.

In the method of the present invention, a laser light source configured to emit the laser light may be a visible-light laser. Alternatively, the laser light source configured to emit the laser light may be an infrared laser.

The laser light source configured to emit the laser light preferably has an output power of 1 W to 100 W.

In the method of the present invention, the laser light preferably has a spot diameter of 0.01 mm to 1 mm.

In the method of the present invention, the step of irradiating may include a step of scanning the laser light according to the predetermined pattern. In this case, the scanning is performed preferably at a rate of 0.5 mm/s to 10 mm/s.

In the method of the present invention, the step of mixing may include a step of dispersing the starch powder in the water. Alternatively, the step of mixing may include a step of spraying the starch powder with the water.

In the method of the present invention, the step of extracting may include a step of applying water to the remaining part of the mixture which has not been irradiated with the laser light, thereby removing the remaining part.

The method of the present invention may further comprises the steps of: additionally providing the mixture onto the mixture which has been partly irradiated with the laser light, and irradiating the additional mixture with the laser light.

The present invention also provides an apparatus for three-dimensionally forming a food using a starch powder as a raw material, wherein the apparatus comprises: mixture providing means to provide a mixture of a starch powder and water; mixture receiving means to receive the mixture from the mixture providing means; a laser module configured to irradiate a part of the mixture received in the mixture receiving means with laser light from a laser light source comprised in the laser module, to cause starch particles of the starch powder to swell due to the water to form swollen starch particles, followed by causing the swollen starch particles to gelatinize to form gelatinized starch particles, and causing the gelatinized starch particles to gelate, thereby obtaining gelated starch; relative position control means to control a relative position between the mixture receiving means and the laser module so as to allow the mixture in the mixture receiving means to be irradiated with the laser light at given positions of the mixture, according to a pattern predetermined based on a three-dimensional shape of a food; and irradiation control means to allow the mixture to be irradiated with the laser light under a given irradiation condition, according to the pattern predetermined based on the three-dimensional shape of the food.

### Effect of Invention

Differently from a conventional technique using, e.g., a self-supporting dough, in the present invention, a food having a desirably shape can be formed from an unshaped mixture such as a slurry, by irradiating a part of the mixture with laser light according to a predetermined pattern to obtain gelated starch constituting the food. Further, since the remaining part of the mixture which has not been irradiated with the laser light does not gelate, it can be easily removed, e.g., by applying water thereto, so that it becomes possible to three-dimensionally form a food having a complicated shape such as a shape having a hollow part created by the removed part. As above, the present invention provides a method for three-dimensionally forming a food with a significantly high degree of freedom in design as compared to conventional techniques. A food three-dimensionally formed by the method of the present invention is composed of the gelated starch, and the non-gelated starch powder is separated from the gelated starch, so that the food can be provided immediately for edible use,

### BRIEF DESCRIPTION OF DRAWINGS

FIG. 1 is a set of schematic diagrams showing the respective outlines of steps in one embodiment of the present invention (bathtub system)

FIG. 2 is a set of schematic diagrams showing the respective outlines of steps in another embodiment of the present invention (bathtub system with stage).

FIG. 3 is a set of schematic diagrams showing the respective outlines of steps in still another embodiment of the present invention (powder bed system with stage).

FIG. 4 is a schematic diagram (perspective view) showing the outline of an apparatus according to one embodiment of the present invention.

FIG. 5A is a perspective view showing data used as a pattern based on a three-dimensional shape of a food, in one embodiment of the present invention.

FIG. 5B is a set of a perspective view, a side view and a top view of a food three-dimensionally formed using the data in FIG. 4A in one embodiment of the present invention.

FIG. 6A is a perspective view showing another data used as a pattern based on a three-dimensional shape of a food, in one embodiment of the present invention.

FIG. 6B is a set of a perspective view, a side view and a top view of a food three-dimensionally formed using the data in FIG. 5A in one embodiment of the present invention.

### DESCRIPTION OF EMBODIMENTS

Some embodiments of the present invention will now be described.

The present invention relates to a method for three-dimensionally forming a food using a starch powder as a raw material, wherein the method comprises at least the steps of:
(a) mixing a starch powder and water together to provide a mixture of the starch powder and the water:
(b) irradiating a part of the mixture with laser light, thereby obtaining gelated starch: and
(c) extracting the gelated starch from the mixture.

Among the above steps, as means to mixing a starch powder and water together in the step (a), it is possible to user a system configured to disperse the starch powder in the water (hereinafter referred to as “bathtub system”), a system configured to spray the starch powder with the water (hereinafter referred to as “powder bed system”), etc.

Further, in the present invention, the step (a) and the step (b) may be repeated. In other words, the method may further comprise the steps of: (d) additionally providing the mixture onto the mixture which has been partly irradiated with the laser light; and (e) irradiating the additional mixture with the laser light (the step (b)), whereby the mixture is laminated in multiple layers so as to three-dimensionally form a food. In this process, a stage for allowing the mixture to be placed thereon may be prepared, and the lamination may be performed by moving the stage (hereinafter referred to as “with stage”).

### <Bathtub System>

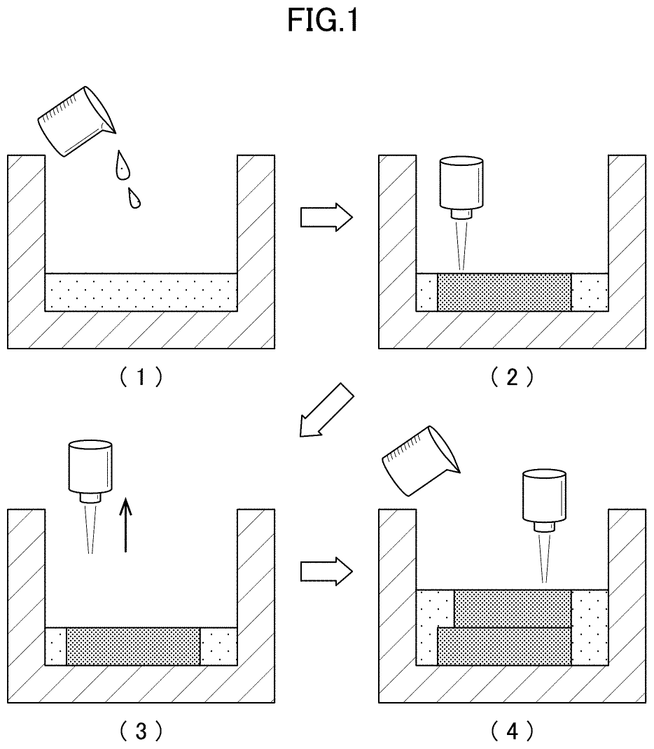

Refereeing to FIG. 1, FIG. 1 shows the respective outlines of steps in the bathtub system.

First of all, a starch powder and water are put in a container such as a beaker, together with a pigment as needed, and mixed under stirring to prepare a starch powder-water mixture, and the prepared starch powder-water mixture is provided into a receptacle (bathtub) to be used for irradiating the mixture with laser light (step (1)).

Subsequently, a part of the mixture is irradiated with the laser light, according to a patter predetermined based in a three-dimensional shape of a food (step (2)). In the part of the mixture irradiated with the laser light, the irradiation causes starch particles of the starch powder to swell due to the water to form swollen starch particles, followed by causing the swollen starch particles to gelatinize to form gelatinized starch particles, and causing the gelatinized starch particles to gelate, thereby obtaining gelated starch.

Immediately after the step (2), the gelated starch may be extracted from the mixture. Alternatively, the provision of the mixture and the irradiation of the mixture with the laser light may be repeated such that the gelated starch is laminated in multiple layers, thereby three-dimensionally forming a food, in the following manner.

Specifically, as need arises, the laser module is moved upwardly (in a z-axis direction) to allow the mixture to be additionally provided onto the mixture which has been partly irradiated with the laser light (first layer), and allow the additional mixture (second layer) to be irradiated with the laser light under the condition that the focal length of the laser light matches the second layer (step (3)).

Subsequently, the mixture prepared in a receptacle such as a beaker is additionally provided onto the mixture which has been partly irradiated with the laser light (first layer), and the additional mixture (second layer) is irradiated with the laser light (step (4)).

After forming by irradiation with the laser light is fully completed, a three-dimensionally formed food composed of the gelated starch is extracted.

In the bathtub system, it is considered that a non-gelatinized part of the mixture fulfills a role like a support material, thereby enabling a three-dimensional formation of a hollow shape or a complicated shape.

<Bathtub System with Stage>

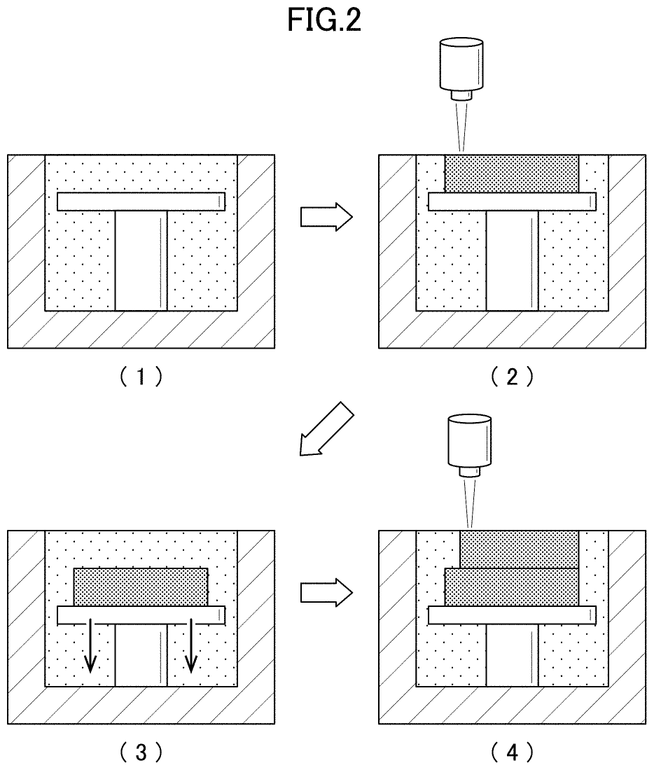

Refer FIG. 2 which shows the respective outlines of steps, in the bathtub system using a stage capable of being moved upwardly and downwardly (z-axis direction).

First of all, an upper portion (platform) of the stage is set at a position where a prepared starch powder-water mixture can be received (and the focal length of the below-mentioned laser light matches the below-mentioned first layer) (step (1))

Subsequently, a receptacle (bathtub) is entirely filled with the mixture, and a part of the mixture provided on the platform is irradiated with laser light, according to a patter predetermined based in a three-dimensional shape of a food (step (2)).

Immediately after the step (2), gelated starch may be extracted from the mixture. Alternatively, the provision of the mixture and the irradiation of the mixture with the laser light may be repeated such that the gelated starch is laminated in multiple layers, thereby three-dimensionally forming a food, in the following manner.

Specifically, the stage is moved downwardly (in the z-axis direction) to allow the mixture to be additionally provided onto the mixture which has been partly irradiated with the laser light (first layer), and allow the additional mixture (second layer) to be irradiated with the laser light under the condition that the focal length of the laser light matches the second layer (step (3)). This makes it possible to eliminate the need for the up-down (z-axis directional) movement of the laser module which is necessary when the stage is not used.

Subsequently, the mixture is additionally provided onto the mixture which has been partly irradiated with the laser light (first layer), and the additional mixture (second layer) is irradiated with the laser light (step (4)).

After forming by irradiation with the laser light is fully completed, a three-dimensionally formed food composed of the gelated starch is extracted.

The bathtub system with stage has been described based on an example in which the platform is configured to be moved downwardly (z-axis direction) by a portion of the stage extending from the bottom of the receptacle (bathtub). Alternatively, the platform may be configured such that it is hung down from above the receptacle (bathtub) using hanging means, and moved downwardly (z-axis direction) by driving the hanging means.

Further, in order to prevent precipitation of the starch powder in the mixture filled in the entire receptacle (bathtub), it is desirable to stir or circulate the mixture in the receptacle (bathtub).

<Powder Bed System with Stage>

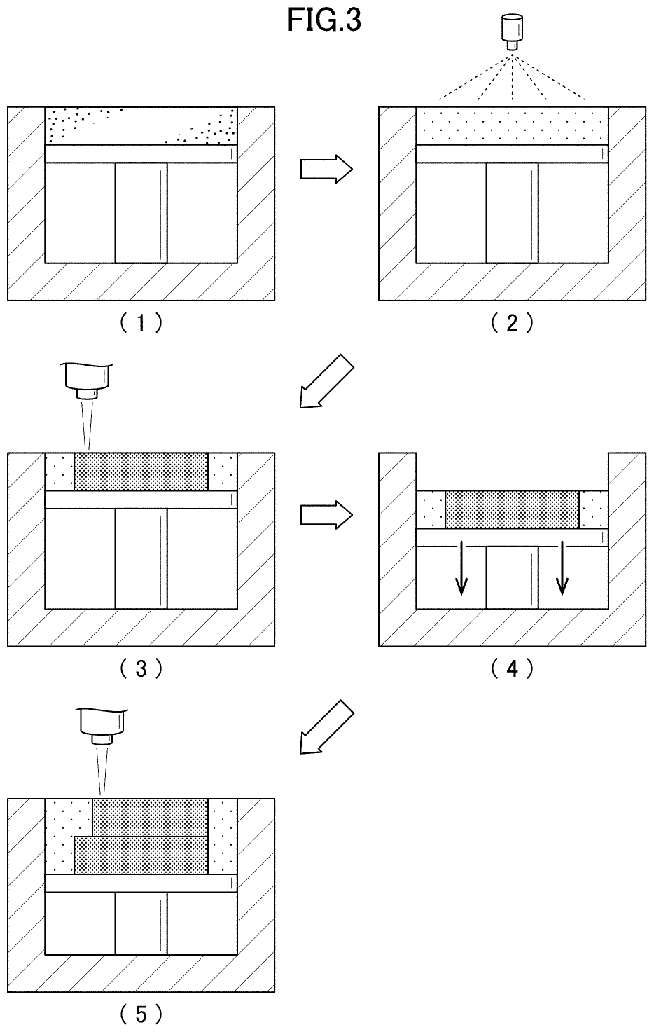

Refer to FIG. 3 which shows the respective outlines of steps, in the powder bed system using a stage capable of being moved upwardly and downwardly (z-axis direction). In the bathtub system, the starch powder-water mixture is prepared by dispersing a starch powder in water. Differently, in the powder bed system, the mixture is prepared by spraying a starch powder with water.

First of all, a platform is set at a position where a starch powder for preparing a starch powder-water mixture can be received (and the focal length of the below-mentioned laser light matches the below-mentioned first layer) (step (1)), and then the starch powder is supplied onto the platform (step (1)).

Subsequently, the starch powder supplied on the platform is sprayed with water to prepare the starch powder-water mixture on the platform so as to provide the mixture to be irradiated with laser light (step (2)).

Subsequently, a part of the mixture provided on the platform is irradiated with laser light, according to a patter predetermined based in a three-dimensional shape of a food (step (3)).

Immediately after the step (3), gelated starch may be extracted from the mixture. Alternatively, the provision of the mixture and the irradiation of the mixture with the laser light may be repeated such that the gelated starch is laminated in multiple layers, thereby three-dimensionally forming a food, in the following manner

Specifically. the stage is moved downwardly (in the z-axis direction) to allow the mixture to be additionally provided onto the mixture which has been partly irradiated with the laser light (first layer), and allow the additional mixture (second layer) to be irradiated with the laser light under the condition that the focal length of the laser light matches the second layer (step (4)).

Subsequently, the starch powder is additionally supplied onto the mixture which has been partly irradiated with the laser light (first layer), and the additionally supplied powder is sprayed with water, thereby providing an additional mixture, whereafter the additional mixture (second layer) is irradiated with the laser light (step (4)).

After forming by irradiation with the laser light is fully completed, a three-dimensionally formed food composed of the gelated starch is extracted.

In the powder bed system, it is considered that a non-gelatinized part of the starch particles fulfill a role like a support material, thereby enabling a three-dimensional formation of a hollow shape or a complicated shape.

When implementing the present invention based on any of the above systems or another system, the present invention requires extracting the gelated starch from the starch powder-water mixture. There are some cases where formation of a food takes a certain amount of time. In such a situation, the starch powder in the mixture is likely to precipitate during the formation. Thus, in a case where the starch powder partly precipitates when carrying out the step of extracting the gelated starch from the mixture after formation of a food, it is preferable to carry out this step, while removing a supernatant solution of the mixture, and washing away the precipitated starch powder by newly supplying water.

### <Starch Powder>

As a starch powder to be used in the present invention, various types of starch powders may be used without any particular limitation. When selecting the starch powder to be used, the amylose content, gelatinization temperature, particle size, etc., of the starch powder may be considered.

### Amylose Content

A low amylose content starch powder, such as a glutinous rice starch powder, generally tends to have a property that a gel is less likely to harden. i.e., a soft gel is formed, and chewy and sticky texture is developed and less likely to change over time.

On the other hand, a high amylose content starch powder, such as a non-glutinous rice starch powder generally tends to have a property that a gel is more likely to harden, i.e., a hard gel is formed, and crispy texture is developed and more likely to harden (retrograde) over time.

The amylose contents of typical starch powders are as follows. waxy corn (0%): glutinous rice (0%): tapioca (17%); non-glutinous rice (15 to 18%); potato (20%); sweet potato (21%); wheat (24%): corn (26%); pea (24 to 28%); and high amylose corn (50 to 80%).

### Gelatinization Temperature

A low gelatinization temperature starch powder is more likely to gelatinize, and when a mixture containing such a starch powder is irradiated with laser light, a large area of the mixture will gelatinize. Thus, formation speed is considered to become faster.

On the other hand, a high gelatinization temperature starch powder is less likely to gelatinize, and when a mixture containing such a starch powder is irradiated with laser light, only a small area of the mixture will gelatinize. Thus, formation accuracy is considered to become higher.

The gelatinization temperature of typical starch powders are as follows: wheat (52 to 67° C.); potato (56 to 66° C.); tapioca (59 to 70° C.); glutinous rice (58 to 80° C.); waxy corn (63 to 72° C.); non-glutinous rice (61 to 78° C.); sweet potato (62 to 80° C.); corn (62 to 74° C.); pea (79° C.); and high amylose corn (110° C.).

### Particle Size

When using a small particle size starch powder, there is a tendency that the starch powder in a starch powder-water mixture (dispersion) is less likely to precipitate. On the other hand, when using a large particle size starch powder, there is a tendency that the starch powder in a starch powder-water mixture (dispersion) is more likely to precipitate.

The particle sizes (μm) of typical starch powders are as follows: non-glutinous rice (2 to 10); glutinous rice (2 to 10); tapioca (4 to 35); peas (2 to 40): corn (6 to 30); waxy corn (6 to 30); high amylose corn (6 to 30): sweet potato (2 to 50); wheat (2 to 40); and potato (2 to 100).

In the present invention, only one type of starch powder may be used, or two or more types of starch powders may be used in combination. For example, it is considered that the texture of a food can be locally changed by using two mixtures comprising different types of starch powders, in a part of the food to be formed into a three-dimensional shape and in the remaining part, respectively.

### <Starch Powder-Water Mixture>

In the present invention, the concentration of the starch powder in the starch powder-water mixture may be appropriately determined.

Generally, there are some cases where when the concentration of the starch powder in the mixture is excessively low (the content of the water in the mixture is excessively high), irradiating the mixture with laser light can cause the swollen starch particles to gelatinize but cannot cause the gelatinized starch particles to gelate. From this standpoint, the starch powder is contained in the starch powder-water mixture used in the present invention preferably at a concentration of at least 10% by mass.

On the other hand, there are some cases where when the concentration of the starch powder in the mixture is excessively high (the content of the water in the mixture is excessively low), irradiating the mixture with laser light cannot cause the swollen starch particles to gelatinize. From this standpoint, the concentration of the starch powder to be contained in the starch powder-water mixture used in the present invention is preferably 90% by mass or less.

The starch powder is contained in the starch powder-water mixture used in the present invention preferably at a concentration of 20% by mass to 80% by mass, more preferably at a concentration of 40% by mass to 60% by mass.

### <Pigment>

The starch powder-water mixture used in the present invention may further comprise a pigment.

The pigment used in the present invention is preferably an edible pigment. The edible pigment may be a food-based pigment or may be a food additive, as long as they do not undermine the effects of the present invention.

### Examples of the Pigment Include the Following

### Orange Pigments

Capsicum pigment, annatto pigment, turmeric pigment, and edible yellow No. 5

### Red Pigments

Red cabbage pigment, red radish pigment, purple potato pigment, purple carrot pigment, elderberry pigment, monascus purpureus pigment, gardenia red pigment, cochineal pigment, lac pigment, red beet pigment, grape skin pigment, amaranth (edible red No. 2), erythrosine (red No. 3), Allura Red AC (red No. 40), new coccine (red No. 102), phloxine (red No. 104), rose bengal (red No. 105), and acid red (red No. 106)

### Yellow Pigments

Palm oil carotene, β-carotene, riboflavin, safflower yellow pigment, gardenia yellow pigment, marigold pigment, and tartrazine (edible yellow No. 4)

### Brown Pigments

Cacao Pigment

### Blue Pigments

Gardenia blue pigment. spirulina blue pigment, brilliant blue FCF (blue No. 1), and indigocarmine (blue No. 2)

### Black Pigments

Vegetable Carbon Black

In the present invention, only one type of pigment may be used, or two or more types of pigments may be used in combination. A desired color can be created by mixing two or more types of pigments among the above pigments, at any ratio. For example, it is possible to mix a safflower yellow pigment and a gardenia blue pigment together to create a green pigment.

In the present invention, it is desirable to use a pigment which exhibits absorption at a wavelength of laser light used.

For example, when light having a wavelength of 450 nm (blue) is used as the laser light, the absorbance of each edible pigment at this wavelength is as follows: blue No. 1: 0.006 [abs]; yellow No. 4: 0.353 [abs]; and red No. 102: 0.159 [abs]. In this case, when the blue No. 1 is added to the mixture, and the resulting mixture is irradiated with the laser light, the mixture is likely to fail to absorb sufficient energy enough to cause the swollen starch particles to gelatinize. On the other hand, when the red No. 102 or the yellow No. 4 is added to the mixture, and the resulting mixture is irradiated with the laser light, it is considered that the mixture can absorb sufficient energy enough to cause the swollen starch particles to gelatinize to form gelatinized starch particles and then cause gelatinized starch particles to gelate. In particular, considering that from a safety standpoint, it is desirable to use the food pigment as an additive in the smallest amounts possible, it is preferable to use the yellow No. 4 whose peak absorbance spectrum is close to the wavelength of the blue laser light.

Although the content of a pigment in the mixture is not particularly limited, it is preferable that the pigment is contained in the mixture at a concentration of 0.001% by mass to 0.5% by mass.

In the present invention, accuracy in forming a food having a three-dimensional shape is considered to be better as the pigment concentration is higher.

On the other hand, it is conceivable that when the pigment concentration becomes extremely high, browning occurs in a formed food. This phenomenon can be utilized, for example, such that when forming a part whose texture or flavor is to be changed, a mixture comprising a pigment at a higher concentration than that in the remaining part is used.

Further, it is conceivable that a layer of starch formed when the mixture additionally containing a pigment at a relatively high concentration is irradiated with laser light becomes thinner as compared to when the mixture additionally containing the pigment at a relatively low concentration is irradiated with the laser light under the same conditions. This is because as the pigment concentration in the mixture becomes higher, the laser light becomes more likely to be absorbed by the mixture, so that the laser light irradiating the mixture from thereabove is absorbed in a shallow part of the mixture and fails to reach a deep part of the mixture. It is to be understood that this phenomenon can also be utilized to adjust the thickness of the starch layer to be formed by adjusting the concentration of a pigment in the mixture.

Commercially available edible pigments are traded in powder form, and since such a pigment alone has an excessively high concentration, it is bulked with polysaccharide such as dextrin. If this bulked pigment is dissolved in water, polysaccharide such as dextrin behaves as a surfactant or a dispersion stabilizer, and can perform action in a solution in which it is mixed.

In the present invention, it should be noted that if a commercially available edible pigment (with a bulking agent) is added to an aqueous dispersion of the starch powder, polysaccharides such as dextrin for bulking can exert an influence on a dispersion state of the starch powder, the rate of swelling of the starch particles by heating, and the speed of binding of the swollen starch particles.

Further, it is predicted that a dispersion state of the pigment is different between in an aqueous solution of the pigment alone and in an aqueous solution containing the pigment and a bulking agent. It should be also noted that this can lead to a change in the absorption spectrum of the pigment.

Specifically, in a case where the pigment in water is dispersed individually at the molecular level, light absorption may be determined by considering only a photoreaction process of the pigment molecule alone. On the other hand, in a case where pigment molecules are dispersed in an aggregated state due to the presence of a bulking agent, the efficiency of light absorption is likely to change by a phenomenon that the energy of absorbed light is transferred to other pigment molecules.

### <Laser>

In the present invention, irradiating a mixture of a starch powder and water with laser light causes starch of the starch powder to swell due to the water to form swollen starch particles, followed by causing the swollen starch particles to gelatinize to form gelatinized starch particles, and causing the gelatinized starch particles to gelate, thereby obtaining gelated starch.

The laser light used in the present invention may be laser light having any of various wavelengths, such as wavelengths in the infrared range, wavelengths in the ultraviolet range, and wavelengths in the visible range. In the present invention, a laser light source configured to emit the laser light may be a visible-light laser or an infrared laser, but it is desirable to consider the following respects.

### (Absorption of Visible Light by Starch)

When irradiating a dispersion of starch particles (it is assumed here that the dispersion does not contain any pigment) with visible laser light, the energy of the irradiation laser light is converted to thermal energy during absorption of the light by the starch particles. However, it is considered that since starch does not exhibit absorption at wavelengths in the visible range, most of the irradiation light is scattered on the surfaces of the starch particles, and efficiency with which light energy is converted to thermal energy when it is absorbed by the starch particles is not high. A phenomenon that a solution in which the starch particles are dispersed appears white suggests that light is elastically scattered without energy absorption on the surface of the starch particles. The fact that the dispersion of the starch particles appears white in itself means that the starch particles are less likely to absorb light.

### (Absorption of Visible Light by Water)

Water is transparent to visible light and does not absorb light. Therefore, it is considered that efficiency with which visible laser light irradiating water is converted to thermal energy to raise the temperature of the water is not high.

From the above, it is considered that when a portion of an aqueous dispersion of the starch particles containing no pigment is irradiated with visible laser light, it is necessary to irradiate the portion of the aqueous dispersion with the laser light to the extent that sufficient energy enough to locally raise the temperature of the dispersion can be supplied.

### (Absorption of Infrared Light by Water)

When using an infrared laser in which an oscillation wavelength is in the infrared range, such as a carbon dioxide laser, it is theoretically possible to raise the temperature of an aqueous solution by irradiating water with infrared laser light, because water exhibits absorption at wavelengths in the infrared range.

However, the infrared absorption of water is generally slight, and, for example, the percentage of infrared rays penetrating through 1 mm-thick water is 70 to 90% or more. Since so-called light penetration (specifically, light penetrates to a depth of about several tens of millimeters) occurs, it is predicted that when infrared laser light is used in a 3D printer, it is not easy to produce resolution in the z-axis direction.

Further, when a cloudy starch powder-water mixture is irradiated with infrared laser light, elastic scattering occurs on the surface of the starch particles, so that multiply scattered light can no longer pass through the interior of a sample linearly, and the light propagates diffusely while repeating random scattering. The area of diffusion at that time is considered to range from several millimeters to several tens of millimeters. This could also be a factor causing deterioration in resolution of the 3D printer.

On the other hand, when a required spatial resolution is about several millimeters, it is possible to optically confine an area to be illuminated with the infrared laser light to about several millimeters by using an objective lens, a pinhole, or an optical fiber. In other words, it is possible to design a 3D printer having a spatial resolution of about several millimeters, using an infrared laser as a light source.

Industrially, a carbon dioxide laser is widely used as a light source for a laser cutter for cutting a solid material by heating and melting. or burning. In this invention, it is possible to irradiate the starch powder-water mixture with carbon dioxide laser light to cause the starch particles to gelatinize, and continuously irradiate the resulting solidified part with the laser light to heat the solidified part to cause the solidified part to carbonize and turn brown, whereby light absorption occurs more efficiently to promote carbonization of the starch. It is considered that the browning means that a chemical change in carbon present in the starch causes a change in the molecular structure of the starch, resulting in a change in the absorption spectrum. From a viewpoint of utilizing this phenomenon, carbon dioxide laser light may be used in the present invention for post-processing of a food after the gelation of the starch powder.

### (Utilization of Pigment)

In the present invention, visible laser light may be used in place of carbon dioxide laser light. When using visible laser light, as mean to efficiently convert light to thermal energy so as to raise the temperature of the dispersion of the starch particles, it is preferable to use a pigment, particularly, a pigment exhibiting absorption at a wavelength of visible laser light.

When using a pigment, it is possible to convert light energy to thermal energy with arbitrary efficiency by selecting an adequate pigment. Thus, in this case, it is possible to use light having various wavelengths.

### (Availability of Visible-Light Laser)

In the present invention, as a laser light source configured to emit laser light, a laser light source having an output power of 1 W to 100 W can be suitably used. Recently, several 10 mW to several 100 mW-class visible-light lasers can be purchased for thousands of yen to tens of thousands of yen, and can be easily selected to fabricate a consumer 3D printers.

(Scanning Rate from Viewpoint of Gelation)

In the present invention, irradiating a part of the starch powder-water mixture with laser light causes starch particles of the starch powder to swell due to the water to form swollen starch particles, followed by causing the swollen starch particles to gelatinize to form gelatinized starch particles, and causing the gelatinized starch particles to gelate, thereby obtaining gelated starch

When raising the local temperature of the aqueous solution by irradiation with the laser light, swelling of the starch particles present in the water and dissolution of amylose contained in the starch are induced. In the subsequent process, contact among the swollen starch particles, and formation of microcrystals occurring after dissolution of amylose bridging the starch particles, promote gelatinization of the starch particles to raise the viscosity of the dispersion, and when the crystal formation reaches a threshold, gelation generating elasticity occurs. Once reaching a temperature condition under which swelling begins, the progress of swelling and the dissolution of amylose proceed at high speed.

Thus, it is considered that the local swelling of the starch particles is sufficiently induced, as long as the duration of the temperature raising process by irradiation with the laser light is about several milliseconds.

In the present invention, in general, the laser light preferably has a spot diameter of 0.01 mm to 1 mm. Further, when the step of irradiating includes a step of scanning the laser light according to the predetermined pattern, the scanning is preferably performed at a rate of 0.5 mm/s to 10 mm/s.

### EXAMPLES OF SPECIFIC NUMERICAL ESTIMATES WILL BE DESCRIBED BELOW

### Example 1: Case where the Spot Diameter is 0.1 mm. And the Scanning Rate is 100 mm/s

In a case where the scanning rate of laser light in a 3D printer is set to 1(0) mm/s, and the spot diameter of the laser light during the canning is set to 0.1 mm, a period of time of irradiation with the 0.1 mm-diameter spot is 0.1 mm 100 mm/s=1 ms.

The diffusion coefficient of water molecules in a normal temperature range is about 10⁻⁹ m²/s. After an elapsed time of 1 ms, the maximum travel distance of water molecules is √(10⁻⁹ m²/s×1 ms)=10⁻⁶ m=1 μm. After an elapsed time of 100 ms, the maximum travel distance of water molecules is √(10⁻⁹ m²/s×100 ms)=10⁻⁶ m=10 μm. After an elapsed time of 10 s, the maximum travel distance of water molecules is √(10⁻⁹ m²/s×10 s)=10⁻⁶ m=0.1 μm. That is, when 10 s has elapsed, water molecules present within the 0.1 mm-diameter spot return to an original water temperature due to dispersion. Realistically, the water molecules are considered to return to the original water temperature within several seconds.

When the spot diameter is 0.1 mm, volume is equivalent to 4π(0.01 cm)³/3=about 0.5 μL (picoliter). The thermal energy required to raise the temperature of 0.5 picoliters of water by 1° C. is 0.5 microcalories, and the thermal energy required to raise the temperature of 0.5 picoliters of water by 100° C. is 50 microcalories, or 0.05 millicalories. This energy is equivalent to 0.2 mJ. Thus, in order to generate 0.2 mJ of heat within 1 ms, a laser source having an output power of 0.2 mJ/1 ms=0.2 W may be used.

### Example 2: Case where the Spot Diameter is 0.2 mm, and the Scanning Rate is 5 mm/s

In a case where the scanning rate of laser light in a 3D printer is set to 5 mm/s, and the spot diameter of the laser light during the canning is set to 0.2 mm, a period of time of irradiation with the 0.2 mm-diameter spot is 0.2 mm 5 mm/s=10 ms.

The diffusion coefficient of water molecules in a normal temperature range is about 10⁻⁹ m²/s. After an elapsed time of 1 ms, the maximum travel distance of water molecules is √(10⁻⁹ m²/s×1 ms)=10⁻⁶ m=1 μm. After an elapsed time of 100 ms, the maximum travel distance of water molecules is √(10⁻⁹ m²/s×100 ms)=10⁻⁶ m=10 μm. After an elapsed time of 10 s, the maximum travel distance of water molecules is √(10⁻⁹ m²/s×10 s)=10⁻⁶ m=0.1 μm. That is, when 10 s has elapsed. water molecules present within the 0.2 mm-diameter spot return to an original water temperature due to dispersion. Realistically, the water molecules are considered to return to the original water temperature within several seconds.

When the spot diameter is 0.2 mm, volume is equivalent to about 4π (0.01 cm)³/3=about 4 pL (picoliter). The thermal energy required to raise the temperature of 4 picoliters of water by 1° C. is 41 microcalories, and the thermal energy required to raise the temperature of of 4 picoliters of water by 100° C. is 400 microcalories, or 0.4 millicalories. This energy is equivalent to 1.6 mJ. Thus, in order to generate 1.6 mJ of heat within 10 ms, a laser source having an output power of 1.6 mJ/10 ms=0.16 W may be used. For example, when a 5W-class laser is used, it is considered that a power of about 1 W can be ensured even if the efficiency of thermal converter is about 20%, and thus sufficient heating can be performed.

### (Scanning Rate and Elastic Modulus of Formed Object)

It is conceivable that as the scanning rate becomes higher, i.e., as the light intensity per unit area of laser light becomes smaller, the elastic modulus of a formed food becomes smaller. This could be because as the light intensity per unit area becomes smaller, the heating temperature of the starch becomes lower, the gelatinization is less likely to progress, and accordingly the elastic modulus becomes smaller.

### (Diversification of Optical Formation-type 3D Printer)

In the present invention, the process of irradiating may consist of, but is not limited to, scanning the laser beam according to the predetermined pattern.

As an optical formation method, there has been known a stereolithography (SLA) system which uses linear laser light such that it is scanned by a galvanometer mirror or the like. Further, there has also been known a system configured to introduce laser light through an optical fiber (“optical fiber system”).

Recently, a system using light from a projector, so-called “DLP (digital light processing) system”, has been increasingly used because it can write in by a plane and thus can significantly speed up the formation as compared to scanning by laser light. In this system, an MEMS device made from hundreds of thousands of tiny micro mirrors enables the projection.

Recently, there has also been known a system configured to induce a reaction by light obtained by allowing UV light of an LED to pass through a liquid crystal filter attached to the bottom of a bathtub, so-called “LED system”. This LCD system can produce high spatial resolution as if laser light were used, with the size and surface density of LCD dots, even without laser light linearly traveling,

Any of the above systems may be employed in the present invention to the extent that the effects of the present invention can be obtained.

### <Three-Dimensionally Food Forming Apparatus>

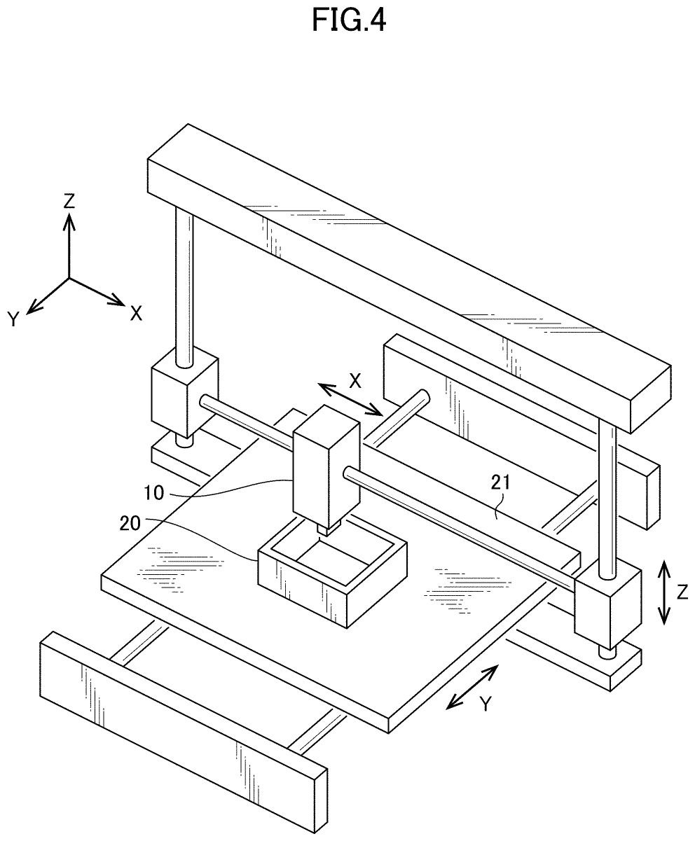

Refer to FIG. 4 which is a schematic diagram (perspective view) showing the outline of an apparatus according to one embodiment of the present invention. The apparatus shown here is an example of an apparatus employing the aforementioned “bathtub system”.

The apparatus of the present invention comprises mixture providing means (not illustrated) to provide a mixture of a starch powder and water, and mixture receiving means, such as a receptacle 20, to receive the mixture from the mixture providing means.

The apparatus also comprises a laser module 10 comprising a laser source. and is configured such that a part of the mixture received in the receptacle 20 is irradiated with laser light from the laser light source, to cause starch particles of the starch powder to swell due to the water to form swollen starch particles, followed by causing the swollen starch particles to gelatinize to form gelatinized starch particles, and causing the gelatinized starch particles to gelate, thereby obtaining gelated starch in the receptacle 20.

The receptacle 20 is placed on a movable surface plate 21. X-directional, y-directional and z-directional relative positions between the receptacle 20 and the laser module 10 are controlled by relative position control means so as to allow the mixture in the receptacle 20 to be irradiated with the laser light from the laser module 10 at given positions of the mixture, according to a pattern predetermined based on a three-dimensional shape of a food. Specifically, the relative positions between the receptacle 20 and the laser module 10 can be controlled by driving a set of a pulley and a belt or a set of a nut and an arm by a stepping motor according to information based on the predetermined pattern.

In the apparatus of the present invention, according to control by irradiation control means (not illustrated), the laser module 10 irradiates the mixture with laser light under a given irradiation condition, according to the pattern predetermined based on the three-dimensional shape of the food.

### EXAMPLES

Although the present invention will be more specifically described below based on examples, it should be understood that the present invention is not limited thereto.

### <Three-Dimensionally Food Forming Apparatus>

A three-dimensionally food forming apparatus (3D printer) equipped with a laser module was fabricated from a 3D printer kit “Geeetech 13 Pro B” manufactured by Geeetech (Shenzhen Getech Co. Ltd). An open-source Repetier-hostV1.6.0 was used as control software for the Geeetech 13 Pro B.

The laser module of the apparatus can be scanned in the x-axis direction by a system in which a set of a pulley and a belt is rotated by a stepping motor.

The apparatus also comprises a movable surface plate capable of allowing a receptacle receiving a mixture therein to be placed thereon. The movable surface plate can be moved in the y-axis direction orthogonal to the x-axis direction by a stepping motor. Base on a combination of the movement of the movable surface plate in the y-axis direction and the scanning of the laser module in the x-axis direction, this apparatus can irradiate the mixture with laser light according to a pattern predetermined based on a three-dimensional shape of a food, while changing the relative position between the laser module and the movable surface plate in the x-y plane. Further, the movable surface plate can be moved in the z-axis direction orthogonal to the x-y plane by a stepping motor. The movement of the movable surface plate in the z-axis direction is performed by connecting a stepping motor and a continuous thread screw, and moving an arm up and down by the movement of a nut when the screw is rotated.

In the apparatus used in the examples, a movable range was set to 200 mm in the x-axis direction, 200 mm in the y-axis direction, and 180 mm in the z-axis direction.

3D data for 3D printers is commonly prepared by slicing a 3D shape to be formed, into rings at regular intervals, using software, called a slicer, and converting them into data for 3D printers, called G-code. This G-code is sent to a 3D printer to form a three-dimensional object having a desired three-dimensional shape.

The 3D printer kit “Geeetech 13 Pro B” is originally designed to fabricate a FDM (Fused Deposition Modeling) 3D printer. The FDM 3D printer is configured to extrude filaments softened by heat from a heater, according rotation of a motor and eject them from a nozzle to form a three-dimensional object. For this reason, information about the extrusion amount of filaments and the temperature of the heater for heating are written in the G-code used in the FDM 3D printers, as formation conditions. In the 3D printer of the present invention, instead of such information, information about operating conditions of the laser module is needed. Thus, in the 3D printer of the present invention, a program written in python was used to allow the G-code used in FDM 3D printers to be converted to G-code used in the 3D printer of the present invention.

As the laser module, plural types of laser modules capable of emitting various wavelengths such as wavelengths in the infrared range, wavelength in the ultraviolet range, and wavelengths in the visible range are conceivable. Assuming that the method for three-dimensionally forming a food becomes popular, it would be desirable to use laser light having a wavelength which can be visually confirmed. From this standpoint, in the following examples, a blue-light laser module using a semiconductor as a laser medium, which is commonly used as a laser with wavelengths in the visible range, was used. The laser module used was a “blue laser module” (wavelength: 450 nm, output power: 5.5 W, spot diameter: 0.2 mm, input voltage: 12 V) manufactured by Alfawise.

### Example 1

First of all, a starch powder, water, and a pigment were mixed together and stirred to produce a pigment-containing starch powder-water mixture (suspension). Immediately after stirring the produced suspension, a part of the suspension corresponding to one of a plurality of layers obtained by slicing a three-dimensional shape to be formed was poured into the receptacle.

The receptacle receiving the suspension therein was placed on the movable surface plate of the 3D printer, and only a part of the suspension to be subjected to gelation of starch was irradiated with laser light, according to a pattern predetermined based on a three-dimensional shape to be formed.

After irradiating the suspension corresponding to the one layer with laser light, in a state in which the receptacle was placed on the movable surface plate, just after stirring the produced suspension, an additional part of the suspension corresponding to the one layer was poured onto a formed object obtained by irradiating the suspension with laser light.

Subsequently, only a part of the additional suspension to be subjected to gelation of starch was irradiated with the laser light according to the predetermined pattern. The above steps are repeated to three-dimensionally form a food composed of stacked gelated starch layers.

Corn starch (trade name: Corn Starch Y) manufactured by Sanwa Starch Co., Ltd., was used as the starch powder, and edible yellow No. 4 manufactured by Daiwa Fine Chemicals Co., Ltd., was used as the pigment. The suspension was produced by putting the cornstarch, water, and the edible yellow No. 4 in the receptacle and stirring the mixture with a medicine spoon. The suspension corresponding to five of the plurality of layers was produced in advance, and wrapped by a wrap so as to prevent vaporization, and stored until just before pouring into the receptacle. The percentages (concentrations) of the starch powder and the edible yellow No. 4 in the produced suspension were set to 50% by mass and 0.03% by mass, respectively.

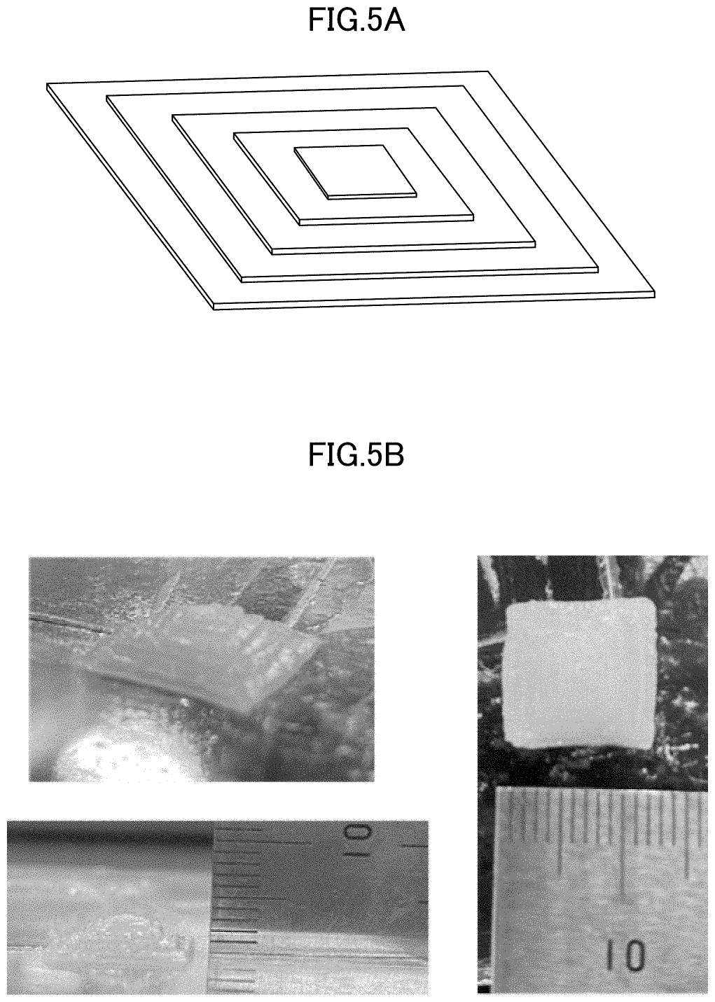

Three-dimensional forming was performed using STL (Stereolithography) data of a pyramid shape as shown in FIG. 5A. In this STL data, the lowermost layer is a square, 10 mm on a side, and the length of one side decreases by 2 mm in ascending order of height position of the layer. Further, the thickness of each layer is set to 0.1 mm. First of all, the suspension stored in a container was stirred and poured into a receptacle having inside dimensions of 30 mm (length)×30 mm (width)×6 mm (height) in an amount corresponding to the one layer (height dimension: 0.5 mm). After the receptacle receiving the suspension therein was placed on the movable surface plate of the 3D printer, a 10 mm×10 mm square area of the first layer was irradiated with laser light under the condition that at the scanning rate was set to 5 mm/s, according to a pattern predetermined based on the STL data, to form a layer having a size of 10 mm×10 mm×0.5 mm. In this process, scanning was performed under the condition that an area (line) where the laser light is scanned and an area (line) where the laser light is subsequently scanned partially overlap so as to prevent a gap from being formed between the two areas.

Next, the suspension was stirred and poured on the formed object obtained by irradiating the suspension in the receptacle with the laser light, in an amount corresponding to the one layer (height dimension: 0.5 mm), in the same manner as that for the first layer. Subsequently. the laser module was raised in the z-axis direction by 0.5 mm such that the focal distance matches the second layer. Then, an 8 mm×8 mm square area of the second layer was irradiated with laser light, according to the pattern predetermined based on the STL data, to form a layer having a size of 8 mm×8 mm×0.5 mmm, such that it is laminated on the first layer.

This operation was repeated up to the fifth layer, and a food having a shape corresponding to the pyramid shape represented by the STL data of was three-dimensionally formed.

Then, the three-dimensionally formed food composed of stacked gelated starch layers was extracted from the suspension in the receptacle. Specifically, it takes about 10 minutes until the step of irradiating is entirely completed, and if the starch in the suspension fully precipitates during that time, it could become difficult to extract the food composed of gelated starch, from the suspension. Thus, when extracting the food from the suspension after completion of the formation, a supernatant solution of the suspension was removed, and the precipitated starch was swashed away while being gradually dissolved by newly supplying water using a dropper, whereafter the food composed of gelated starch was extracted.

The obtained food three-dimensionally formed into a pyramid shape is shown in FIG. 5B.

It is understood from FIG. 5B that the present invention is capable of highly-accurate formation in 1 mm increments. Further, it has been observed that the layers are firmly bonded to each other. Thus, starch particles in the suspension are deemed to gelatinize by irradiation with laser light during the formation. It is observed from FIG. 5B that the dimensions of the formed food are slightly greater than those of the original STL data. This may be due to the fact that the food is observed in a state in which the starch particles absorb water of the suspension and swell.

### Example 2

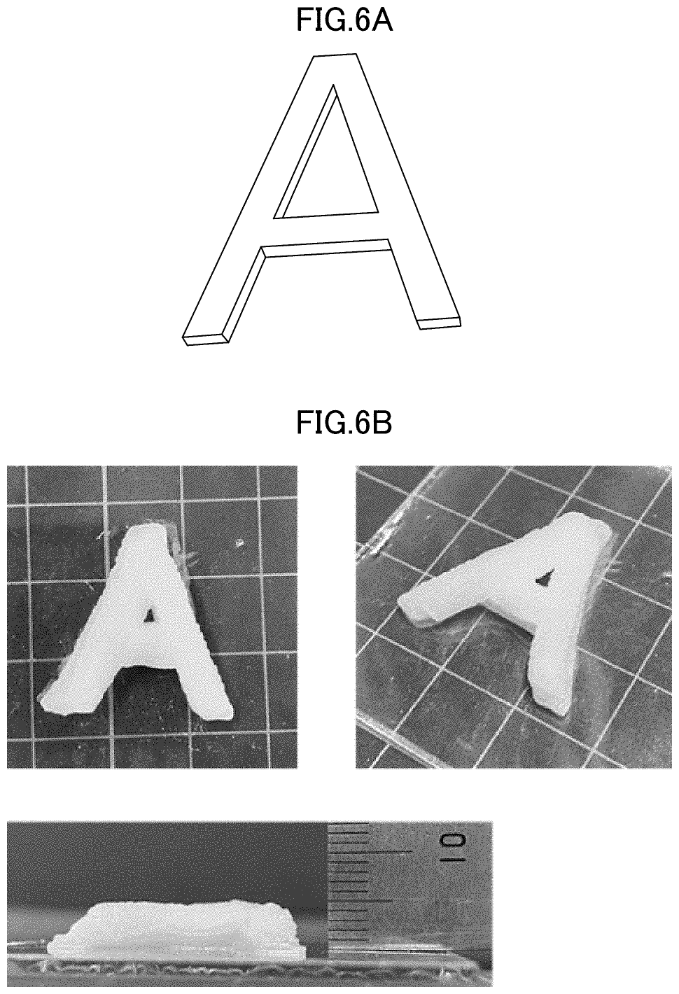

Instead of the STL data of the pyramid shape, STL data of an “A” shape as shown in FIG. 6A was used, and except that the operation was repeated up to the eighth layer, a food was three-dimensionally formed in the same way as that in Example 1.

The dimensions of the “A” shape during formation were set to 18 mm×20 mm.

The obtained food three-dimensionally formed into the “A” shape is shown in FIG. 6B.

It is deemed from FIG. 6B that according to the present invention, it is possible to three-dimensionally form a food with a high degree of accuracy. even if it has a complicated shape which is partially hollowed as in a three-dimensional “A” shape.

### Examples 3 to 5—Consideration of Concentration of Starch Powder—)

The types of suspensions in which the percentage (concentration) of the starch powder is 50% by mass, 40% by mass, and 60% by mass, respectively were prepared, and using each of the suspensions, a food was three-dimensionally formed in the same manner as that in Example 1, except that a part of the suspension corresponding to the one layer was irradiated with the laser light using STL data of a rectangular parallelepiped shape having a size of 10 mm (length)×10 mm (wide)×0.1 mm (height), instead of the STL data of the pyramid shape. The result is summarized in Table 1.

TABLE 1

| | Concentration | Property | | |
|---|---|---|---|---|
| | of starch powder | during | Property after | Formation |
| Example | (% by mass) | stirring | stirring | accuracy |
| 3 | 40 | slight | equal to water | ◯ |
| | | resistance | | |
| 4 | 50 | normal | slightly viscous | ⊚ |
| | | resistance | | |
| 5 | 60 | large | extremely viscous | ⊚ |
| | | resistance | | |

It is understood from the result that when the suspension is stirred and poured into the receptacle, the lower concentration of the starch powder in the suspension provides easier handleability.

On the other hand, it has been observed that the formation accuracy particularly in an area where the laser irradiation begins becomes better as the concentration of the starch powder becomes higher.

### Examples 6 to 9—Consideration of Concentration of Pigment—)

Four types of suspensions in which the percentage (concentration) of the pigment is 0.03% by mass, 0.02% by mass, 0.09% by mass, and 0.27% by mass, respectively were prepared, and using each of the suspensions, a food was three-dimensionally formed in the same manner as that in Example 4 (Example 4 is identical to Example 7). The result is summarized in Table 2.

TABLE 2

| | Concentration of pigment | Formation | |
|---|---|---|---|
| Example | (% by mass) | accuracy | Browning |
| 6 | 0.02 | ◯ | Absence |
| 7 | 0.03 | ⊚ | Absence |
| 8 | 0.09 | ⊚ | Absence |
| 9 | 0.27 | ⊚ | Presence |

It is deemed from the result that the formation accuracy particularly in an area where the laser irradiation begins becomes better as the concentration of the pigment becomes higher.

On the other hand, when the concentration of the pigment was significantly high, browning was observed in a formed food. This phenomenon can be utilized, for example, such that when forming a part whose texture or flavor is to be changed, a mixture comprising a pigment at a higher concentration than that in the remaining part is used.

### Examples 10 to 13—Consideration of Concentration of Scanning Rate—)

In four cases where the laser light scanning rate is set to 5 mm/s, 1.25 mm/s, 2.5 mm/s, and 10 mm/s. respectively, a food was three-dimensionally formed in the same manner as that in Example 4 (Example 4 is identical to Example 12). The result is summarized in Table 3.

TABLE 3

| | Scanning Rate | Formation | |
|---|---|---|---|
| Example | (mm/s) | accuracy | Browning |
| 10 | 1.25 | ⊚ | Presence |
| 11 | 2.5 | ⊚ | Absence |
| 12 | 5.0 | ⊚ | Absence |
| 13 | 10 | ◯ | Absence |

It is deemed from the result that the formation accuracy particularly in an area where the laser irradiation begins becomes better as the scanning rate becomes lower.

On the other hand, when the scanning rate was significantly low, browning was observed in a formed food. This phenomenon can be utilized, for example, such that when forming a part whose texture or flavor is to be changed, such a part is irradiated with the laser light at a scanning rate lower than that in the remaining part.

### Examples 14 to 17—Consideration of Type of Starch Powder—)

In four cased where cornstarch, non-glutinous rice starch (trade name: Fine Snow, manufactured by Joetsu Starch Co., Ltd.), glutinous rice starch (trade name: Motiel B, manufactured by Joetsu Starch Co., Ltd.,), and potato starch (trade name: Refined Starch, manufactured by Eastern Tokachi Federation of Agroprocessing/Agricultural Cooperatives) are used, respectively, a food was three-dimensionally formed in the same manner as that in Example 2, except that STL data of a rectangular parallelepiped shape having a size of 10 mm (length)×10 mm (wide)×0.8 mm (height) was used, instead of the STL data of the “A” shape. However, considering that different types of starch powders have different viscosities even when they are contained in the mixture at the same concentration, the concentration of each of the starch powders was adjusted such that the starch powders have similar viscosities. The result is summarized in Table 3.

TABLE 4

| | | Formation | |
|---|---|---|---|
| Example | Starch powder | accuracy | Properties of formed object |
| 14 | Cornstarch | ⊚ | Low viscosity, relatively hard, |
| | | | hard to stretch |
| 15 | Non-glutinous | ⊚ | Low viscosity, relatively hard, |
| | rice starch | | hard to stretch |
| 16 | Glutinous | ⊚ | Slightly high viscosity, |
| | rice starch | | slightly hard |
| 17 | Potato starch | ◯ | High viscosity/tackiness, |
| | | | stretchable |

From the result, it is conceivable, for example that when there is a need to partly change the texture of a food to be formed, two mixtures containing different types of starch powders are used in a certain part of the food and in the remaining part, respectively.

### LIST OF REFERENCE SIGNS

10: laser module
20: receptacle
21: movable surface plate

1. A method for three-dimensionally forming a food using a starch powder as a raw material, comprising the steps of:
mixing a starch powder and water together to provide a mixture of the starch powder and the water;
irradiating a part of the mixture with laser light to cause starch particles of the starch powder to swell due to the water to form swollen starch particles, followed by causing the swollen starch particles to gelatinize to form gelatinized starch particles, and causing the gelatinized starch particles to gelate, thereby obtaining gelated starch; and
extracting the gelated starch from the mixture,
wherein the step of irradiating includes irradiating the mixture with the laser light, according to a pattern predetermined based on a three-dimensional shape of a food.

2. The method as recited in claim 1, wherein the starch powder is contained in the mixture at a concentration of 20% by mass to 80% by mass.

3. The method as recited in claim 1, wherein the starch powder is contained in the mixture at a concentration of 40% by mass to 60% by mass.

4. The method as recited in claim 1, wherein the mixture further comprises a pigment.

5. The method as recited in claim 4, wherein the pigment is an edible pigment

6. The method as recited in claim 4, wherein the pigment exhibits absorption at a wavelength of the laser light.

7. The method as recited in claim 4, wherein the pigment is contained in the mixture at a concentration of 0.001% by mass to 0.5% by mass.

8. The method as recited in claim 1, wherein a laser light source configured to emit the laser light is a visible-light laser.

9. The method as recited in claim 1, wherein a laser light source configured to emit the laser light is an infrared laser.

10. The method as recited in claim 1, wherein a laser light source configured to emit the laser light has an output power of 1 W to 100 W.

11. The method as recited in claim 1, wherein the laser light has a spot diameter of 0.01 mm to 1 mm.

12. The method as recited in claim 1, wherein the step of irradiating includes a step of scanning the laser light according to the predetermined pattern.

13. The method as recited in claim 12, wherein the scanning is performed at a rate of 0.5 mm/s to 10 mm/s.

14. The method as recited in claim 1, wherein the step of mixing includes a step of dispersing the starch powder in the water.

15. The method as recited in claim 1, wherein the step of mixing includes a step of spraying the starch powder with the water.

16. The method as recited in claim 1, wherein the step of extracting includes a step of applying water to the remaining part of the mixture which has not been irradiated with the laser light, thereby removing the remaining part.

17. The method as recited in claim 1, further comprising the steps of: additionally providing the mixture onto the mixture which has been partly irradiated with the laser light; and irradiating the additional mixture with the laser light.

18. An apparatus for three-dimensionally forming a food using a starch powder as a raw material, comprising:
mixture providing means to provide a mixture of a starch powder and water;
mixture receiving means to receive the mixture from the mixture providing means;
a laser module configured to irradiate a part of the mixture received in the mixture receiving means with laser light from a laser light source comprised in the laser module, to cause starch particles of the starch powder to swell due to the water to form swollen starch particles, followed by causing the swollen starch particles to gelatinize to form gelatinized starch particles, and causing the gelatinized starch particles to gelate, thereby obtaining gelated starch;
relative position control means to control a relative position between the mixture receiving means and the laser module so as to allow the mixture in the mixture receiving means to be irradiated with the laser light at given positions of the mixture, according to a pattern predetermined based on a three-dimensional shape of a food; and
irradiation control means to allow the mixture to be irradiated with the laser light under a given irradiation condition, according to the pattern predetermined based on the three-dimensional shape of the food.
